(19) United States
(12) Patent Application Publication
(10) Pub. No.: US 2025/0167221 A1
(43) Pub. Date: May 22, 2025

(54) ELECTRODE FOR SECONDARY BATTERY, MANUFACTURING METHOD THEREOF, AND LITHIUM SECONDARY BATTERY

(71) Applicant: SK ON CO., LTD., Seoul (KR)

(72) Inventor: Byoung-Ho KO, Daejeon (KR)

(21) Appl. No.: 18/841,397

(22) PCT Filed: Mar. 22, 2023
(86) PCT No.: PCT/KR2023/003779

§ 371 Date: Aug. 26, 2024

(30) Foreign Application Priority Data
May 16, 2022 (KR) 10-2022-0059362

(51) Int. Cl. H01M 4/36; H01M 4/02; H01M 4/04; H01M 10/052

(52) U.S. Cl. CPC H01M 4/366; H01M 4/0404; H01M 10/052; H01M 2004/021

(57) ABSTRACT

An electrode for a secondary battery according to one embodiment of the present invention comprises: a current collector; a first electrode mixture layer disposed on the current collector and including a first active material and a first binder; and a second electrode mixture layer disposed on the first electrode mixture layer and including a second active material and a second binder, wherein the weight ratio of the first binder in the first electrode mixture layer is equal to or greater than the weight ratio of the second binder in the second electrode mixture layer, and the electrode adhesive force with the current collector is 0.37 N/18 mm or greater. According to one embodiment of the present invention, provided are an electrode for a secondary battery having excellent electrode adhesion, resistance characteristics, etc., and a method for manufacturing same.

### CROSS-REFERENCE TO RELATED APPLICATIONS

This application is a national stage application of PCT/KR2023/003779 filed on Mar. 22, 2023, which claims priority of Korean patent application number 10-2022-0059362 filed on May 16, 2022. The disclosure of each of the foregoing applications is incorporated herein by reference in its entirety.

### TECHNICAL FIELD

The present disclosure relates to an electrode for a secondary battery having excellent resistance characteristics, adhesion, and the like, a method for manufacturing the same, and a lithium secondary battery including the same.

### BACKGROUND ART

As interest in environmental issues has increased recently, research into an electric vehicle (EV), a hybrid electric vehicle (HEV), and the like, that can replace a vehicle using fossil fuel such as a gasoline vehicle, a diesel vehicle, and the like, one of the main causes of air pollution, has been actively conducted. A lithium secondary battery having a high discharge voltage and output stability is mainly used as a power source of such an electric vehicle (EV), a hybrid electric vehicle (HEV), and the like, and development and research on an electrode for a secondary battery that may be applied to a high-performance lithium secondary battery have also been actively conducted.

In order to improve the performance of the electrode for a secondary battery, such as resistance characteristics, adhesion, and the like, the development of an electrode for a secondary battery having a multilayer structure has recently been actively conducted. In the case of an existing single-layer electrode, there is a limit to satisfying all the characteristics required for upper and lower portions of the electrode, respectively, based on an electrode surface thereof in contact with a current collector or electrolyte. On the other hand, a multilayer electrode allows the characteristics of each layer to be adjusted differently, and it is possible to design an optimized structure and composition by considering the characteristics required for the upper and lower portions of the electrode.

Accordingly, research is being actively conducted to manufacture an electrode having more improved performance, as compared to the existing electrode for a secondary battery by adjusting the characteristics of each layer in the multilayer electrode.

### SUMMARY OF INVENTION

### Technical Problem

An aspect of the present disclosure is to provide an electrode for a secondary battery with a multilayer structure and excellent adhesion, resistance characteristics, and the like.

An aspect of the present disclosure is to provide a method for manufacturing an electrode for a secondary battery which is excellent in terms of processability and which can alleviate deterioration in electrode adhesion.

### Solution to Problem

According to an aspect of the present disclosure, an electrode for a secondary battery includes: a current collector; a first electrode mixture layer located on the current collector, and including a first active material and a first binder; and a second electrode mixture layer located on the first electrode mixture layer, and including a second active material and a second binder, wherein a weight ratio of the first binder to the first electrode mixture layer is greater than or equal to a weight ratio of the second binder to the second electrode mixture layer, and electrode adhesion with the current collector is 0.37 N/18 mm or more.

A molecular weight of the second binder may be greater than a molecular weight of the first binder.

A weight average molecular weight (M_{w}) of the first binder may be 900,000 or less, and a weight average molecular weight (M_{w}) of the second binder may be 950,000 or more.

The electrode for a secondary battery may have a bulk resistance value of 5.5 Ω·cm or less.

The electrode for a secondary battery may have an interfacial resistance value of 0.035 Ω·cm² or more.

According to an aspect of the present disclosure, a method for manufacturing an electrode for a secondary battery includes: forming a first electrode mixture layer on a current collector with a first slurry including a first active material and a first binder; and forming a second electrode mixture layer on the first electrode mixture layer with a second slurry including a second active material and a second binder, wherein a weight ratio of the first binder to the first electrode mixture layer is greater than or equal to a weight ratio of the second binder to the second electrode mixture layer, and a molecular weight of the second binder is greater than a molecular weight of the first binder.

The first binder may be included in an amount of 0.8 to 1.5 parts by weight based on 100 parts by weight of the first electrode mixture layer, and the second binder may be included in an amount of 0.05 to 0.8 parts by weight based on 100 parts by weight of the second electrode mixture layer.

A weight average molecular weight (M_{w}) of the first binder may be 900,000 or less, and a weight average molecular weight (M_{w}) of the second binder may be 950,000 or more.

The first binder and the second binder may respectively be polyvinylidene fluoride (PVDF) having different molecular weights.

A difference in solids contents between the first slurry and the second slurry may be 3.5% or less.

A difference in viscosity between the first slurry and the second slurry may be 3,500 cP or less.

According to an aspect of the present disclosure, a lithium secondary battery includes the electrode for a secondary battery described above.

### Advantageous Effects of Invention

As set forth above, according to an embodiment of the present disclosure, an electrode for a secondary battery with a multilayer structure with excellent adhesion, resistance characteristics, and the like, is provided.

According to an aspect of the present disclosure, a method for manufacturing an electrode for a secondary battery is provided, wherein the electrode for a secondary battery has excellent slurry application processability by reducing a difference in solids contents between each slurry for forming the multilayer electrode mixture layer, and can alleviate deterioration in electrode adhesion when the applied slurry is dried.

### BRIEF DESCRIPTION OF DRAWINGS

FIG. 1 is a conceptual diagram schematically illustrating a structure of an electrode for a lithium secondary battery according to an embodiment of the present disclosure.

### BEST MODE FOR INVENTION

Hereinafter, various implementations according to the present disclosure will be described, but the embodiments may be modified in many different forms, and the scope thereof is not limited to the implementations described below.

As described above, when a multilayer electrode structure, other than a conventional single-layer electrode structure, is applied, electrode performance may be optimized by adjusting characteristics of each layer independently.

When manufacturing an electrode with such a multilayer structure, when a content of a binder of a layer (an upper layer) in which an electrode is disposed on a surface adjacent to an electrolyte is lower than a content of a binder of a layer (a lower layer) in which an electrode is disposed on a surface adjacent to a current collector, adhesion between the current collector and the electrode may be maintained to be excellent, and resistance characteristics of the electrode may also be improved by lowering the content of the binder of the entire electrode and facilitating the movement of ions and electrons at an interface between the electrode and the electrolyte.

However, when the content of the binder of the upper layer is adjusted to be relatively low, a problem in which viscosity of the slurry for forming the upper electrode mixture layer becomes very low, may occur. Accordingly, when the viscosity of the slurry for forming the upper layer is too low, or if the difference in viscosity between each slurry disposed in the upper and lower layers is excessively large, the processability when applying the slurry to form a multilayer electrode may deteriorate.

To solve this problem, a solids content of the slurry disposed in the upper layer may be increased, but in this case, a difference in solids contents between each slurry disposed in the upper and lower layers thereof occurs. According to the difference in solids contents of the upper and lower layers, a phenomenon in which the binder moves along with liquid components from a portion (bottom) having a low solids content to a portion (top) having a high solids content during an operation of drying the coated slurry, which is a so-called binder migration phenomenon may accelerate. In this case, as the content of the binder disposed at the bottom decreases, a problem in which the adhesion between the electrode and the current collector decreases more than expected. In addition, due to this binder migration phenomenon, a conductive material included in the slurry may also move together, which may result in more improved resistance characteristics and lower conductivity than expected.

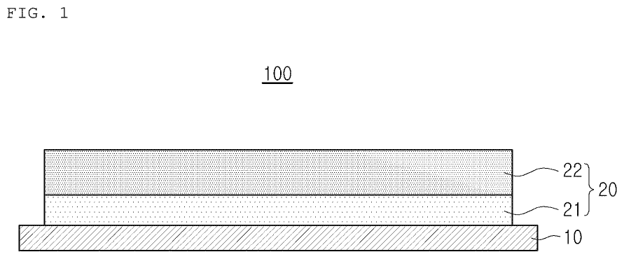

The inventors of the present disclosure have invented a method for manufacturing an electrode with a multilayer structure that can substantially alleviate the above-described problems, and specific embodiments thereof are disclosed below with reference to FIG. 1.

FIG. 1 is a conceptual diagram schematically illustrating a structure of an electrode for a lithium secondary battery according to an embodiment of the present disclosure.

### Method for Manufacturing an Electrode for Secondary Battery

According to an aspect of the present disclosure, a method for manufacturing an electrode for a secondary battery 100 includes forming a first electrode mixture layer 21 on a current collector with a first slurry including a first active material and a first binder; and forming a second electrode mixture layer 22 on the first electrode mixture layer with a second slurry including a second active material and a second binder, and a weight ratio of a first binder to the first electrode mixture layer is greater than or equal to a weight ratio of a second binder to the second electrode mixture layer, and a molecular weight of the second binder is greater than a molecular weight of the first binder.

The first slurry refers to a slurry for forming a first electrode mixture layer (lower layer) disposed on one surface adjacent to the current collector.

The second slurry refers to a slurry for forming a second electrode mixture layer (upper layer) disposed on the first electrode mixture layer.

In order to adjust a content of the binder in the second slurry forming the second electrode mixture layer (upper layer) to be relatively lower than a content of the binder in the first slurry forming the first electrode mixture layer (lower layer), a ratio of the content of the first binder included in the first slurry may be greater than a ratio of the content of the second binder included in the second slurry. Specifically, the weight ratio of the first binder to the total weight of the first slurry may be greater than the weight ratio of the second binder to the total weight of the second slurry. Accordingly, the weight ratio of the first binder to the first electrode mixture layer may also be greater than or equal to the weight ratio of the second binder to the second electrode mixture layer.

The first binder may be included in an amount of 0.8 to 1.5 parts by weight, or 1.0 to 1.4 parts by weight, based on 100 parts by weight of the first electrode mixture layer.

The second binder may be included in an amount of 0.05 to 0.8 parts by weight, or 0.1 to 0.5 parts by weight, based on 100 parts by weight of the second electrode mixture layer.

When the contents of the first binder and the second binder is within the above-described range, the content of the binder of the upper layer, as compared to that of the lower layer may be reduced, so that excellent adhesion between the electrode and the current collector may be maintained while also efficiently improving electrode resistance characteristics.

However, as described above, when the content of the binder of the upper layer is relatively reduced, as compared to the lower layer, a problem related to slurry viscosity and solids content thereof may occur. Accordingly, in the method for manufacturing an electrode for a secondary battery according to an embodiment of the present disclosure, a binder with a higher molecular weight than that of the lower layer may be applied as the binder for the upper layer. That is, the molecular weight of the second binder may be greater than the molecular weight of the first binder. Specifically, a weight average molecular weight (M_{w}) of the second binder may be greater than a weight average molecular weight (M_{w}) of the first binder.

The weight average molecular weight (M_{w}) of the first binder may be 900,000 or less. In addition, the weight average molecular weight (M_{w}) of the first binder may be 800,000 or more, or 850,000 or more.

The weight average molecular weight (M_{w}) of the second binder may be 950,000 or more. Specifically, the weight average molecular weight (M_{w}) of the second binder may be 1,000,000 or more, 1,200,000 or more, 1,300,000 or more, and 1,500,000 or less.

A ratio of the weight average molecular weight (M_{w}) of the second binder to the first binder may be 1.1 or more, 1.3 or more, 1.5 or more, and may be less than 1.60.

As described above, when a binder with a higher molecular weight than that of the lower layer is used as the binder of the upper layer, and each molecular weight value is appropriately adjusted, even if the content of the binder of the upper layer is lowered, a decrease in slurry viscosity can be minimized. Accordingly, an excessively high slurry solids content may also be alleviated, and a problem caused by a difference in slurry viscosity and solids content between the upper and lower layers can be substantially suppressed.

The first binder and the second binder are the same type of compound and may have different molecular weights. That is, the first binder and the second binder are polymers polymerized based on the same monomer, and may be compounds having different molecular weights depending on differences in some functional groups, degree of polymerization, and the like.

Specifically, the first binder and the second binder may respectively be polyvinylidene fluoride (PVDF) having different molecular weights. More specifically, the first binder and the second binder may respectively be polyvinylidene fluoride (PVDF) having different weight average molecular weights (M_{w}).

A difference in solids contents between the first slurry and the second slurry may be 3.5% or less. Specifically, the difference in solids contents between the first slurry and the second slurry may be 2% or less, 1.5% or less, 1% or less, 0.01% or more, and 0.1% or more.

A solids content of the first slurry may be 70 to 75%.

A solids content of the second slurry may be 74 to 78%.

The solids content may be a value based on weight.

When a solids content value between the first slurry and the second slurry and the difference therebetween are within the above-described range, the difference in solids contents between the slurry of the upper and lower layers may be reduced, so that the occurrence of a binder migration phenomenon may be substantially alleviated during a drying operation of the mixture layer, and accordingly, an electrode having excellent adhesion may be manufactured.

A difference in viscosity between the first slurry and the second slurry may be 3,500 cP or less. Specifically, the difference in viscosity between the first slurry and the second slurry may be 3,000 cP or less, 2,500 cP or less, 1,000 cP or more, and 2,000 cP or more.

The viscosity of the first slurry may be 9,000 to 12,000 cP, or 10,000 to 11,000 cP.

The viscosity of the second slurry may be 5,000 to 9,000 cP, 7,500 to 9,000 cP, 8,000 to 9,000 cP, or 8,500 to 9,000 cP.

When the difference in viscosity between the upper and lower layers is too large, spread control during slurry coating is not easily performed, so that a problem such as an uneven coating width, loading deviation, and the like, may occur, and when the viscosity of the upper layer is too low, a problem such as precipitation may occur. When a viscosity value between the first slurry and the second slurry and the difference therebetween are within the above-described range, the slurry viscosity of the upper and lower layers may be maintained to be within an appropriate range, and the difference in viscosity between the slurry of the upper and lower layers may be also adjusted not to be too large, so that excellent processability may be secured by effectively alleviating the above-described problems, when slurry coating to form a multilayer electrode mixture layer.

A loading weight (LW) of the first electrode mixture layer and the second electrode mixture layer refers to an amount of each electrode mixture layer formed on a current collector is expressed in units of weight per area (mg/cm²). In this case, the area is based on an area of the current collector, and the weight is based on a total weight of the electrode mixture layer formed.

A loading weight (LW) of the first electrode mixture layer may be 5 to 15 mg/cm².

A loading weight (LW) of the second electrode mixture layer may be 5 to 15 mg/cm².

A ratio of the loading weight (LW) of the second electrode mixture layer to the first electrode mixture layer may be 0.25 to 4.

When the loading weight (LW) of the first electrode mixture layer and the second electrode mixture layer and the ratio thereof are within the above-described range, an amount in which a second electrode mixture layer (an upper layer), adjacent to an electrolyte and a first electrode mixture layer (a lower layer), adjacent to a current collector are coated, may be adjusted within an appropriate range, respectively, so that an electrode having high performance may be manufactured by optimizing the composition of the active material, binder, and the like, of the entire electrode.

The electrode for a secondary battery may be a cathode for a secondary battery.

The first active material and the second active material may be a cathode active material of a lithium secondary battery, respectively. The cathode active material may be a lithium-transition metal oxide such as lithium cobalt oxide (LiCoO₂), lithium manganese oxide (LiMn₂O₄), or lithium nickel oxide (LiNiO2), or a lithium-transition metal complex oxide in which a portion of the transition metals are substituted with other transition metals. Specifically, the lithium-transition metal complex oxide may be an NCM-based cathode active material represented by a chemical formula LiₓNiₐCo_{b}Mn_{c}O_{y}(0<x≤1.1, 2≤y≤2.02, 0<a<1, 0<b<1, 0<c<1, 0<a+b+c≤1). In addition, the first active material and the second active material may be a lithium iron phosphate (LFP)-based cathode active material represented by a chemical formula LiFePO₄, respectively.

Forming a first electrode mixture layer on the current collector with a first slurry including the first active material and the first binder may be performed by a process of applying a first slurry including the first active material and the first binder on the current collector by a method such as bar coating, casting, spraying, or the like, and drying and rolling the first slurry. In this case, the first slurry may include a first solvent and a first conductive material.

Forming a second electrode mixture layer on the first electrode mixture layer with a second slurry including the second active material and the second binder may be performed by a process of applying a second slurry including the second active material and the second binder on the first electrode mixture layer by a method such as bar coating, casting, spraying, or the like, and drying and rolling the second slurry. In this case, the second slurry may include a second solvent and a second conductive material.

The solvent may be added to obtain excellent uniformity by appropriately dissolving or dispersing the active material, binder, and the like, in the slurry for forming the electrode mixture layer. The first and second solvents may include, for example, dimethyl sulfoxide (DMSO), isopropyl alcohol, N-methylpyrrolidone (NMP), acetone, or water. It is sufficient for an amount of the solvent used to dissolve or disperse the active material, the conductive material, and the binder in consideration of a coating thickness and manufacturing yield of the slurry for forming the electrode mixture layer, and then to have a viscosity that can exhibit excellent thickness uniformity when applied to form the electrode mixture layer.

The conductive material is a conductive material that can improve electronic conductivity in the electrode without causing chemical changes in the battery, and is a component that can contribute to maintaining the structure of the electrode. The first and second conductive materials may be any one selected from carbon nanotubes (CNTs) such as multi-wall CNTs, single-wall CNTs, and the like; graphite such as natural graphite, artificial graphite, or the like; carbon black such as carbon black, acetylene black, ketjen black, channel black, furnace black, lamp black, and summer black; conductive fiber such as carbon fiber, metal fiber, or the like; metal powder particles such as carbon fluoride, aluminum, and nickel powder, conductive whiskers such as zinc oxide and potassium titanate, conductive metal oxides such as titanium oxide, and conductive materials such as polyphenylene derivatives. The types of the first conductive material and the second conductive material may be the same or different as needed.

### Lithium Secondary Battery (100)

The electrode for a secondary battery 100 according to an embodiment of the present disclosure includes a current collector 10; a first electrode mixture layer 21 located on the current collector, and including a first active material and a first binder; and a second electrode mixture layer 22 located on the first electrode mixture layer, and including a second active material and a second binder, wherein a weight ratio of the first binder to the first electrode mixture layer is greater than or equal to a weight ratio of the second binder to the second electrode mixture layer, and electrode adhesion with the current collector is greater than 0.37 N/18 mm.

The first electrode mixture layer may be formed of a first slurry including a first active material and a first binder, and the second electrode mixture layer may be formed of a second slurry including a second active material and a second binder. In this case, the weight ratio of the first binder to the total weight of the first slurry may be greater than the weight ratio of the second binder to the total weight of the second slurry. Accordingly, the weight ratio of the first binder to the first electrode mixture layer may also be greater than or equal to the weight ratio of the second binder to the second electrode mixture layer.

However, in the final manufactured electrode for a secondary battery, a boundary between the first electrode mixture layer (the lower layer) and the second electrode mixture layer (the upper layer) respectively formed of the first slurry and the second slurry described above, may be unclear when observed in an entire electrode. Therefore, when the content of the binder in the first slurry for forming the first electrode mixture layer is adjusted to be relatively higher than the content of the binder in the second slurry for forming the second electrode mixture layer, in the final manufactured electrode, a different binder content distribution based on the top and bottom (i.e., a distribution with a higher binder content in the bottom compared to the top) without a clear distinction between the first electrode mixture layer and the second electrode mixture layer.

In this case, in the electrode for a secondary battery according to an embodiment of the present disclosure, when the entire electrode is divided into two in the thickness direction based on a surface in which a current collector and an electrode are in contact with each other, the content of the binder included in the portion, adjacent to the current collector may be greater than the content of the binder included in the portion, spaced further apart from the current collector.

The electrode for a secondary battery may be a cathode for a secondary battery.

Detailed descriptions of the first active material, second active material, first binder, second binder, and the like are omitted since they overlap with the above description.

The electrode for a secondary battery may be manufactured by the method for manufacturing an electrode for a secondary battery described above.

The electrode for a secondary battery is an electrode with a multilayer structure, and a content of a first binder in a lower layer may be greater than a content of a second binder in an upper layer. Accordingly, as described above, the electrode for a secondary battery has excellent resistance characteristics as compared to an electrode with a single-layer structure.

Adhesion of the electrode for a secondary battery with the current collector may be 0.37 N/18 mm or more. Specifically, adhesion of the electrode for a secondary battery with the current collector may be 0.40 N/18 mm or more, 0.45 N/18 mm or more, 1 N/18 mm or less, 0.6 N/18 mm or less, and 0.5 N/18 mm or less.

When the adhesion of the electrode for a secondary battery is within the above-described range, the adhesion can also be secured at an excellent level within the range in which the electrode resistance characteristics described below are not substantially reduced.

A molecular weight of the second binder may be greater than a molecular weight of the first binder. Specifically, a weight average molecular weight (M_{w}) of the first binder may be 900,000 or less, and a weight average molecular weight (M_{w}) of the second binder may be 950,000 or more. A detailed description of the molecular weight of the first binder and the second binder is omitted since it overlaps with the above description.

The electrode for a secondary battery may have a bulk resistance value of 5.5 Ω·cm or less. Specifically, the electrode for a secondary battery may have a bulk resistance value of 5 Ω·cm or less, 4.7 Ω·cm or less, 1 Ω·cm or more, and 4 Ω·cm or more.

Actual resistance characteristics in the electrode mixture layer can be confirmed by measuring the bulk resistance value for the electrode. Therefore, when the bulk resistance value of the electrode for a secondary battery is within the above-described range, electrode resistance characteristics can also be improved to an excellent level within a range in which electrode adhesion is not substantially reduced.

The electrode for a secondary battery may have an interfacial resistance value of 0.035 Ω·cm² or more. Specifically, the electrode for a secondary battery may have an interface resistance value of 0.04 Ω·cm² or more, 0.042 Ω·cm² or more, 0.1 Ω·cm² or less, and 0.05 Ω·cm² or less.

By measuring the interfacial resistance value for the electrode, the resistance of a local area near the current collector can be confirmed, thereby, a degree of distribution of the binder can be confirmed. Specifically, as the binder migration phenomenon is alleviated, the binder can be evenly distributed near the current collector, increasing the interfacial resistance when value. Accordingly, the interfacial resistance value of the electrode for a secondary battery is within the above-described range, the binder in the electrode mixture layer may be evenly distributed as the binder migration phenomenon is substantially alleviated.

### Lithium Secondary Battery

A lithium secondary battery according to an embodiment of the present disclosure includes the electrode for a secondary battery described above.

Specifically, the lithium secondary battery may include the electrode for a secondary battery as a cathode.

When the lithium secondary battery includes the electrode for a secondary battery described above, by including an electrode with excellent adhesion, resistance characteristics, and the like, the lithium secondary battery does not have a problem such as electrode detachment, and have excellent performance.

### MODE FOR INVENTION

### Example

Hereinafter, the present disclosure will be described in more detail through examples. The following examples are intended to illustrate the present disclosure in more detail, and are not intended to limit the present disclosure thereto.

### 1. Manufacturing of Cathode

### (1) Examples 1 to 3

70 g of LiNi_{0.8}CO_{0.1}Mn_{0.1}O₂ was included as a first active material, 1.3 parts by weight of PVDF (KUREHA, KF9700) was included as a first binder based on 98.1 parts by weight of the first active material, a first slurry including 0.6 parts by weight of multi-walled carbon nanotubes (MWCNT) was manufactured as a conductive material, and the first slurry was applied to a current collector (aluminum foil) having a thickness of 20 μm at 12.35 mg/cm², to form a first electrode mixture layer.

Thereafter, a second active material having the same content as the first active material, was included, a second slurry including 0.4 parts by weight of a second binder (SOLVAY, S5145), which is a PVDF binder having a different molecular weight from the first binder, based on 99.0 parts by weight of the second active material was applied onto the first electrode mixture layer at 12.35 mg/cm², and dried and rolled at 120° C. to form a second electrode mixture layer, and a double-layer cathode including a first electrode mixture layer and a second electrode mixture layer was manufactured.

Cathodes of Examples 2 and 3 were manufactured in the same manner of Example 1, except that a PVDF binder (Example 2: SOLVAY, S5140; Example 3: SOLVAY, S5130) having a different molecular weight from the second binder in Example 1 was applied as the second binder, respectively.

### (2) Comparative Examples 1 to 3

A double-layer cathode was manufactured in the same manner as the cathode of Example 1, but a cathode having a different specific binder type and content, upper/lower layer solids content, and the like, for each layer was manufactured.

### (3) Comparative Example 4

A slurry including the same active material, binder, and conductive material as the cathode of Example 1, but including 1.2 parts by weight of a binder based on 98.2 parts by weight of the active material was applied to a current collector (aluminum foil) having a thickness of 20 μm at a concentration of 24.7 mg/cm², to form a first electrode mixture layer, and dried and rolled at 120° C. to form a cathode including a single-layer electrode mixture layer.

Specific properties such as a composition, coating method, solids content, viscosity, and the like, of the cathodes of Examples 1 to 3 and Comparative Examples 1 to 4, were shown in Table 1 below.

In this case, the viscosity of the slurry is a value measured based on a shear rate of 4.64s⁻¹ using a rheometer viscometer at 25° C., and the solids content thereof is a value based on the weight.

TABLE 1

| | Example | Example | Example | Comparative | Comparative | Comparative | Comparative |
|---|---|---|---|---|---|---|---|
| | 1 | 2 | 3 | Example 1 | Example 2 | Example 3 | Example 4 |
| Coating method | Double | Double | Double | Double | Double | Double | Single |
| | layer (D/L) | layer (D/L) | layer (D/L) | layer (D/L) | layer (D/L) | layer (D/L) | layer (S/L) |
| Composition of | MWCNT | MWCNT | MWCNT | MWCNT | — | MWCNT | MWCNT |
| conductive material | 0.6% | 0.6% | 0.6% | 0.6% | | 0.6% | 0.6% |
| Type of binder | S5145/ | S5140/ | S5130/ | KF9700/ | KF9700/ | KF9700/ | KF9700 |
| (upper/lower | KF9700 | KF9700 | KF9700 | KF9700 | S5145 | KF9700 | |
| layer) | | | | | | | |
| Content of | 0.4%/ | 0.4%/ | 0.4%/ | 0.4%/ | 0.4%/ | 0.2%/ | 1.2% |
| binder (upper/ | 1.3% | 1.3% | 1.3% | 1.3% | 1.3% | 1.3% | |
| lower layer) | | | | | | | |
| Molecular weight | 1,350,000/ | 1,200,000/ | 1,000,000/ | 880,000/ | 880,000/ | 880,000/ | 880,000 |
| of binder (M_{w}) | 880,000 | 880,000 | 880,000 | 880,000 | 1,350,000 | 880,000 | |
| Solids content | 74.62/ | 75.27/ | 75.98/ | 77.91/ | 77.91/ | 80.41/ | 74.31 |
| of upper/lower | 74.05 | 74.05 | 74.05 | 74.05 | 72.01 | 74.05 | |
| layer (%) | | | | | | | |
| Difference in | 0.57 | 1.22 | 1.93 | 3.86 | 5.90 | 6.36 | 0.00 |
| solids contents | | | | | | | |
| between upper/ | | | | | | | |
| lower layer (%) | | | | | | | |
| Rheometer | 8,942/ | 8,325/ | 7,794/ | 7,283/ | 7,283/ | 9,788/ | 12,790 |
| viscosity of | 10,950 | 10,950 | 10,950 | 10,950 | 10,950 | 10,950 | |
| upper/lower | | | | | | | |
| layer (cP) | | | | | | | |
| Difference in | 2,008 | 2,625 | 3,156 | 3,667 | 4,059 | 1,162 | 0 |
| viscosity | | | | | | | |
| between upper/ | | | | | | | |
| lower layer (cP) | | | | | | | |

### 2. Manufacturing of Anode and Unit Cell

60 g of graphite and 5.342 g of SiOx were used as an active material, an anode slurry respectively including 1.002 g and 0.868 g of styrene-butadiene rubber (SBR) and carboxymethyl cellulose (CMC) as a binder, was applied to copper foil, and then dried and rolled to manufacture an anode.

Porous polyethylene (PE) was used as a separator, and an electrolyte dissolved with LiPF₆ of 1M, having an EC: EMC volume ratio of 3:7 was used as an electrolyte, and unit cells of each of Examples and Comparative Examples were manufactured with the cathode and the anode manufactured above.

### 3. Performance Evaluation

### (1) Electrode Adhesion

After cutting each manufactured cathode into a size of 18 mm in width and 150 mm in length, a tape having a width of 18 mm was attached to the current collector, and a roller with a load of 2 kg was used to ensure sufficient adhesion.

Thereafter, the electrode mixture layer was adhered to one side of a tensile tester (IMADA, DS2-50N) using a double-sided tape, and then the tape attached to the current collector was fastened to the opposite side of the tensile tester to measure adhesion. The results thereof were shown in Table 2.

### (2) Resistance Characteristics

For each manufactured anode, an electrode was placed on an electrode resistance meter (HIOKI, XF057) and a multi-probe was contacted to measure a bulk resistance value and an interfacial resistance value, which were shown in Table 2 below.

TABLE 2

| | Example | Example | Example | Comparative | Comparative | Comparative | Comparative |
|---|---|---|---|---|---|---|---|
| | 1 | 2 | 3 | Example 1 | Example 2 | Example 3 | Example 4 |
| Electrode | 0.48 | 0.43 | 0.39 | 0.35 | 0.28 | 0.24 | 0.52 |
| adhesion | | | | | | | |
| [N/18 mm] | | | | | | | |
| Bulk | 4.6 | 4.9 | 5.2 | 5.7 | 6.6 | 7.7 | 9.4 |
| resistance | | | | | | | |
| [Ω · cm] | | | | | | | |
| Interfacial | 0.043 | 0.041 | 0.037 | 0.033 | 0.031 | 0.029 | 0.044 |
| resistance | | | | | | | |
| [Ω · cm²] | | | | | | | |

Referring to Tables 1 and 2, it was found to be relatively excellent in cells including the cathodes of Comparative Examples 1 to 3 having a double-layer electrode structure, as compared to cells including the cathode of Comparative Example 4 having a single-layer electrode structure, but electrode adhesion was found to be lowered. In addition, in the cell including the cathode of Comparative Example 4 with a single-layer electrode structure, the electrode adhesion was found to be high, but the bulk resistance value was also found to be high, so that the resistance characteristics were found to be deteriorated. On the other hand, in the cell including the cathode of Examples 1 to 3, both electrode adhesion and resistance characteristics were found to be relatively excellent.

Considering this, it is determined that excellent resistance characteristics can be secured when the content of the binder of the upper layer is relatively lowered by using a double-layer electrode structure, other than single-layer electrode structure. In addition, even if the electrode structure has the same double layer type, when the difference in solids contents of the slurry for forming the upper and lower layers is relatively low, the binder migration phenomenon between the slurry of the upper and lower layers may be efficiently suppressed, so that it is determined so that electrode adhesion can also be maintained at an excellent level.

Therefore, in a multilayer electrode structure as in Example 1, when the content of the binder of the upper layer slurry is adjusted to relatively low level, and a binder with a relatively high molecular weight is included in the upper layer slurry, t is determined that excellent resistance characteristics and electrode adhesion can be secured at the same time.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

### Industrial Applicability

As described above, the features of the present disclosure may be applied in whole or in part to an electrode for a secondary battery, a method of manufacturing the same, and a lithium secondary battery.

1. An electrode for a secondary battery, comprising:
a current collector;
a first electrode mixture layer located on the current collector, and including a first active material and a first binder; and
a second electrode mixture layer located on the first electrode mixture layer, and including a second active material and a second binder,
wherein a weight ratio of the first binder to the first electrode mixture layer is greater than or equal to a weight ratio of the second binder to the second electrode mixture layer, and
electrode adhesion with the current collector is 0.37 N/18 mm or more.

2. The electrode for a secondary battery of claim 1, wherein a molecular weight of the second binder is greater than a molecular weight of the first binder.

3. The electrode for a secondary battery of claim 1, wherein a weight average molecular weight (M_{w}) of the first binder is 900,000 or less, and
a weight average molecular weight (M_{w}) of the second binder is 950,000 or more.

4. The electrode for a secondary battery of claim 1, wherein a bulk resistance value is 5.5 Ω·cm or less.

5. The electrode for a secondary battery of claim 1, wherein an interfacial resistance value is 0.035 Ω·cm² or more.

6. A method for manufacturing an electrode for a secondary battery, comprising:
forming a first electrode mixture layer on a current collector with a first slurry including a first active material and a first binder; and
forming a second electrode mixture layer on the first electrode mixture layer with a second slurry including a second active material and a second binder,
wherein a weight ratio of the first binder to the first electrode mixture layer is greater than or equal to a weight ratio of the second binder to the second electrode mixture layer, and
a molecular weight of the second binder is greater than a molecular weight of the first binder.

7. The method for manufacturing an electrode for a secondary battery of claim 6, wherein the first binder is included in an amount of 0.8 to 1.5 parts by weight based on 100 parts by weight of the first electrode mixture layer, and
the second binder is included in an amount of 0.05 to 0.8 parts by weight based on 100 parts by weight of the second electrode mixture layer.

8. The method for manufacturing an electrode for a secondary battery of claim 6, wherein a weight average molecular weight (M_{w}) of the first binder is 900,000 or less,
a weight average molecular weight (M_{w}) of the second binder is 950,000 or more.

9. The method for manufacturing an electrode for a secondary battery of claim 6, wherein the first binder and the second binder are respectively polyvinylidene fluoride (PVDF) having different molecular weights.

10. The method for manufacturing an electrode for a secondary battery of claim 6, wherein a difference in solids contents between the first slurry and the second slurry is 3.5% or less.

11. The method for manufacturing an electrode for a secondary battery of claim 6, wherein a difference in viscosity between the first slurry and the second slurry is 3,500 cP or less.

12. A lithium secondary battery, comprising:
the electrode for a secondary battery of claim 1.
